(19) United States
(12) Patent Application Publication
(10) Pub. No.: US 2024/0340515 A1
(43) Pub. Date: Oct. 10, 2024

(54) CAMERA MODULE AND IMAGE SENSOR MODULE

(71) Applicant: SAMSUNG ELECTRO-MECHANICS CO., LTD., Suwon-si (KR)

(72) Inventor: Janghun KIM, Suwon-si (KR)

(73) Assignee: SAMSUNG ELECTRO-MECHANICS CO., LTD., Suwon-si (KR)

(21) Appl. No.: 18/592,669

(22) Filed: Mar. 1, 2024

(30) Foreign Application Priority Data
Apr. 7, 2023 (KR) 10-2023-0046028

(51) Int. Cl. H04N 23/54; H04N 23/51; H04N 23/55

(52) U.S. Cl. CPC H04N 23/54; H04N 23/51; H04N 23/55

(57) ABSTRACT

A camera module includes a lens barrel; a housing accommodating the lens barrel; an image sensor, disposed below the lens barrel in an optical axis direction, mounted on a main substrate; an optical filter disposed between the image sensor and the lens barrel; and a sub-housing, disposed between the lens barrel and the main substrate, comprising a mounting region on which the optical filter is mounted, and a rim region disposed around the mounting region. The mounting region includes a seating portion on which at least a part of a lower surface of the optical filter is seated, an intermediate portion extending outward and above from the seating portion and lower than an upper surface of the optical filter, and a protruding portion disposed on an outer side of at least a part of the intermediate portion and protruding upward.

### CROSS-REFERENCE TO RELATED APPLICATIONS

This application claims the benefit under 35 USC 119(a) of Korean Patent Application No. 10-2023-0046028 filed on Apr. 7, 2023, in the Korean Intellectual Property Office, the entire disclosure of which is incorporated herein by reference for all purposes.

### BACKGROUND

### 1. Field

The following description relates to a camera module and an image sensor module.

### 2. Description of the Background

Optical filters included in camera modules are assembled in various ways. The optical filter may be attached to a drive device or a sub-housing. In some instances, the optical filter may be assembled to a lowermost end of a lens. Optical filters may be assembled into camera modules through sub-housings, which may be advantageous in terms of unit prices or management.

The method of attaching the optical filter to the sub-housing has a problem in which flares are caused by light entering through a lateral surface of the optical filter.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a lens barrel; a housing accommodating the lens barrel; an image sensor, disposed below the lens barrel in an optical axis direction, mounted on a main substrate; an optical filter disposed between the image sensor and the lens barrel; and a sub-housing, disposed between the lens barrel and the main substrate, comprising a mounting region on which the optical filter is mounted, and a rim region disposed around the mounting region. The mounting region includes a seating portion on which at least a part of a lower surface of the optical filter is seated, an intermediate portion extending outward and above from the seating portion and lower than an upper surface of the optical filter, and a protruding portion disposed on an outer side of at least a part of the intermediate portion and protruding upward.

In the optical axis direction, the protruding portion may be disposed closer to the lens barrel than the rim region is to the lens barrel.

In the optical axis direction, the protruding portion may be disposed closer to the lens barrel than the intermediate portion is to the lens barrel.

The intermediate portion disposed within the protruding portion may have an arc shape.

The seating portion may have a quadrangular shape. The protruding portion may include a pair of protruding portions disposed outside a pair of facing edges of the seating portion, respectively.

The seating portion may have a pair of long side surfaces and a pair of short side surfaces, and the protruding portions may be disposed on outside edges of the pair of long side surfaces.

A maximum height of the protruding portion may be larger than a height of a rim portion disposed outside edges of the pair of short side surfaces of the seating portion.

The intermediate portion may be disposed outside an edge of each of four sides of the seating portion, and the intermediate portion may have a tapered profile.

The seating portion may have a pair of long side surfaces and a pair of short side surfaces. A lowermost portion profile of the intermediate portion disposed outside edges of the long side surfaces may increase toward the short side surfaces.

The intermediate portion disposed within the protruding portion may have an arc shape.

The rim portion may include a convex portion having an arc shape protruding outward from edges of the long side surfaces.

The protruding portion may have an arc shape.

The protruding portion may overlap the lens barrel in the optical axis direction.

The intermediate portion having the arc shape may have an extension portion protruding outward from the arc shape.

The intermediate portion may include a stepped portion, and the stepped portion may have a portion protruding outward.

In another general aspect, an image sensor module include a main substrate; an image sensor disposed on the main substrate; an optical filter disposed on the image sensor; and a sub-housing, disposed on the main substrate, comprising a mounting region on which the optical filter is mounted, and a rim region disposed around the mounting region. The mounting region includes a seating portion on which at least a part of a lower surface of the optical filter is seated, an intermediate portion extending outward from the seating portion and being higher than the seating portion and lower than the optical filter, and a protruding portion disposed outside at least a part of the intermediate portion and being convex outward in a plan view.

The protruding portion may protrude further than the rim region in a direction opposite to the main substrate.

The protruding portion may protrude further than the intermediate portion in a direction opposite to the main substrate.

The intermediate portion disposed inside the protruding portion may have an arc shape.

The seating portion may have a quadrangular shape, and the protruding portion may include a pair of protruding portions disposed outside a pair of facing edges of the seating portion, respectively.

Other features and aspects will be apparent from the following detailed description, the drawings, and the claims.

### BRIEF DESCRIPTION OF THE DRAWINGS

FIG. 1 is a perspective view illustrating an external appearance of a camera module according to one embodiment.

FIG. 2 is an exploded perspective view schematically illustrating the camera module illustrated in FIG. 1.

FIG. 3 is a perspective view illustrating a sub-housing of the camera module illustrated in FIG. 2.

FIG. 4 is a cross-sectional view taken along line IV-IV′ in FIG. 3.

FIG. 5 is a cross-sectional view taken along line V-V′ in FIG. 3.

FIG. 6 is a perspective view illustrating a sub-housing of a camera module according to another embodiment.

FIG. 7 is a cross-sectional view taken along line VII-VII′ in FIG. 6.

FIG. 8 is a cross-sectional view taken along line VIII-VIII′ in FIG. 6.

FIG. 9 is a perspective view illustrating a sub-housing of a camera module according to still another embodiment.

FIG. 10 is a perspective view illustrating a sub-housing of a camera module according to yet another embodiment.

FIG. 11 is a perspective view illustrating a sub-housing of a camera module according to still yet another embodiment.

FIG. 12 is a cross-sectional view illustrating a state in which flare is caused by a sub-housing according to a comparative example.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

In addition, throughout the specification, the word “in a plan view” means when an object is viewed from above, and the word “in a cross-sectional view” means when a cross section made by vertically cutting an object is viewed from a lateral side.

Hereinafter, various embodiments and modified examples will be described in detail with reference to the drawings. A height described below means a distance defined in an optical axis direction from a reference point, and the height needs to be understood as being different from a thickness. A description of the height may mean a relative position based on an optical axis direction (a z-axis direction in the drawings). That is, the description “A is higher than B’ needs to be understood as meaning that A is positioned to be closer to a light incidence direction than B to the light incidence direction.

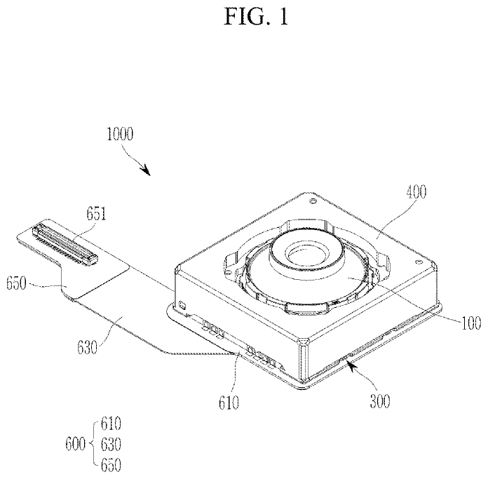

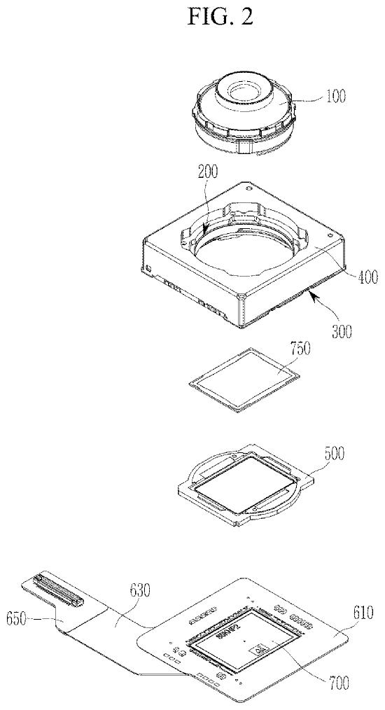

FIG. 1 is a perspective view illustrating an external appearance of a camera module according to an embodiment, and FIG. 2 is an exploded perspective view schematically illustrating the camera module illustrated in FIG. 1.

With reference to FIGS. 1 to 2, a camera module 1000, according to one embodiment, may include a lens barrel 100, a lens driving part 200, a housing 300, a cover 400, a sub-housing 500, and a substrate part 600.

The lens barrel 100 may have a hollow cylindrical shape to accommodate a plurality of lenses used to capture an image of a subject. The plurality of lenses may be aligned in an optical axis direction (z-axis direction) and mounted in the lens barrel 100. The plurality of lenses may be disposed in a state in which a desired number of lenses is determined in accordance with the design of the lens barrel 100. The respective lenses may have the same or different optical characteristics, such as refractive indexes.

The lens driving part 200 may provide the driving power desired to operate the lens barrel 100. The lens driving part 200 may include an autofocus (AF) driving part configured to adjust a focal point, and an optical image stabilizer (OIS) driving part configured to correct hand-shaking or swaying.

For example, the lens driving part 200 may adjust the focal point by moving the lens barrel 100 in the optical axis direction (z-axis direction) by using the AF driving part. The lens driving device 200 may correct swaying at the time of capturing an image by moving the lens barrel 100 in a direction perpendicular to the optical axis direction (z-axis direction) by using the OIS driving part.

The housing 300 may accommodate the lens barrel 100 and the lens driving part 200 in an internal space thereof. The housing 300 may have a polyhedral shape with an approximately quadrangular cross-section and a predetermined height. However, the present disclosure is not limited thereto. For example, the housing 300 may have a box-shaped opening on the upper and lower sides.

The cover 400 may be coupled to the housing 300 so as to surround an outer surface of the housing 300. The cover 400 may protect internal configuration components in the camera module 1000. In addition, the cover 400 may serve to block electromagnetic waves. For example, the cover 400 may block electromagnetic waves so that the electromagnetic waves generated in the camera module 1000 do not affect the other electronic components in an electronic device.

An image sensor module may include an image sensor 700, a main substrate 610 on which the image sensor 700 is mounted, an optical filter 750 positioned above the image sensor 700, and the sub-housing 500 on which the optical filter 750 is mounted.

The substrate part 600 may transmit electrical signals generated from the image sensor 700 to devices such as a camera phone. The substrate part 600 may include the main substrate 610, a connection substrate 630, and a connector 650.

The main substrate 610 may be electrically connected to the lens driving part 200. The main substrate 610 may be a printed circuit board (PCB) or a flexible printed circuit board (FPCB). The connector 650 may be electrically connected to the main substrate 610. The connector 650 may include a port 651 that may be electrically connected to an external device. The connection substrate 630 may electrically connect the main substrate 610 and the connector 650. The connection substrate 630 may include an FPCB.

The image sensor 700 may be mounted on the main substrate 610. The image sensor 700 may be electrically connected to the main substrate 610. The image sensor 700 may be positioned below the lens barrel 100 in the optical axis direction Z. The image sensor 700 may be positioned in the sub-housing 500.

The optical filter 750 may be positioned between the lens barrel 100 and the image sensor 700. The optical filter 750 may prevent light beams with a particular frequency band among the light beams passing through the lens from entering the image sensor 700. The optical filter 750 may include an infrared filter. The optical filter 750 may be disposed to be parallel to a direction perpendicular to the optical axis direction (Z-axis direction). The optical filter 750 may be mounted in the sub-housing 500.

An image may be formed on the image sensor 700 as the light passes through the lens and the filter part 750 enters the image sensor 700. The image sensor 700 may convert light emitted to an effective image region into an electrical signal. For example, the image sensor 700 may be, but not limited to, any one of a charge-coupled device (CCD), a metal oxide semiconductor (MOS), a CPD, and a CID.

Hereinafter, according to the present embodiment, the sub-housing 500 of the camera module 1000 will be more specifically described with reference to FIGS. 1, 2, and 3.

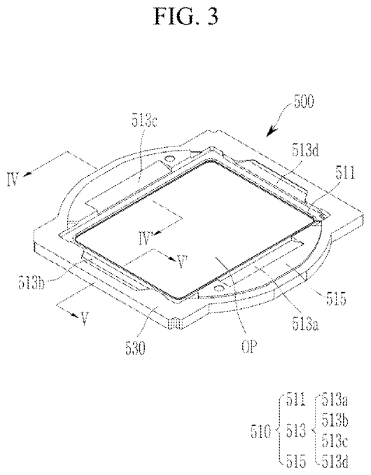

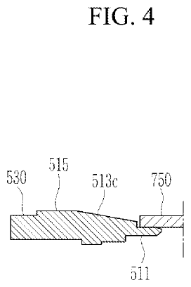

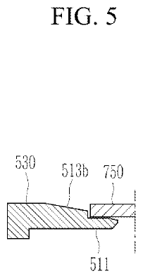

FIG. 3 is a perspective view illustrating a sub-housing of the camera module illustrated in FIG. 2, FIG. 4 is a cross-sectional view taken along line IV-IV′ in FIG. 3, and FIG. 5 is a cross-sectional view taken along line V-V′ in FIG. 3.

The sub-housing 500 may be positioned between the lens barrel 100 and the main substrate 610. An opening portion OP may be positioned in a central portion of the sub-housing 500. The image sensor 700 may overlap the opening portion OP in the sub-housing 500 in the optical axis direction. The opening portion OP of the sub-housing 500 may have a quadrangular planar shape.

The sub-housing 500 may include a mounting region 510, where the optical filter 750 is mounted, and a rim region 530 positioned around the mounting region 510.

The mounting region 510 may include a seating portion 511 on which the optical filter 750 is seated, an intermediate portion 513 extending outward from the seating portion 511, and a protruding portion 515 positioned on an outer side of the intermediate portion 513.

The optical filter 750 may be seated on the seating portion 511. The seating portion 511 may be formed around the opening portion OP. For example, the opening portion OP may have a quadrangular shape. The seating portion 511 may have a quadrangular frame shape formed around the opening portion OP.

The optical filter 750 may be positioned on the seating portion 511, such that at least a part of a lower surface of the optical filter 750 may be seated on the seating portion 511. For example, the optical filter 750 may have a quadrangular shape, and the edges of the lower surface of the optical filter 750 may be seated on the seating portion 511 with the quadrangular frame shape.

The intermediate portion 513 may extend outward from the seating portion 511. For example, the intermediate portion 513 may extend from all sides of the seating portion 511 with a quadrangular frame shape. That is, at least one intermediate portion 513 may be positioned outside each of the four sides of the seating portion 511.

The intermediate portion 513 may extend outward from a part of the seating portion 511. For example, the seating portion 511 may extend from a middle portion of each of the sides of the seating portion 511 with a quadrangular frame shape.

With reference to FIGS. 4 and 5, the intermediate portion 513c (513) may be higher in height than the seating portion 511. In addition, the intermediate portion 513 may be lower in height than the optical filter 750 seated on the seating portion 511. In this case, the height may be determined based on an upper or upper side surface. For example, the intermediate portion 513 may have a height smaller than the height of the upper surface of the optical filter 750 seated on the seating portion 511.

With reference to FIG. 3, the intermediate portion 513 may have a quadrangular shape. The intermediate portion 513 may have a tapered structure that becomes higher outward.

With reference to FIGS. 3 and 4, the protruding portion 515 may be positioned outside the intermediate portion 513. The protruding portion 515 may have a shape convex outward in a plan view. The protruding portion 515 may have a higher height than the intermediate portion 513. The protruding portion 515 may protrude upward, i.e., in a light incidence direction. That is, the protruding portion 515 may be positioned to be closer to the lens barrel 100 in the optical axis direction Z than the intermediate portion 513 to the lens barrel 100. In addition, the protruding portion 515 may be higher in height than the rim region 530. That is, the protruding portion 515 may be positioned to be closer to the lens barrel 100 in the optical axis direction (z-axis direction) than the rim region 530 to the lens barrel 100.

With reference to FIGS. 3 to 5, the protruding portions 515 may be formed only on the outer sides of some of the intermediate portions 513. For example, among the four intermediate portions 513, respectively extending from the four sides of the seating portion 511, having a quadrangular frame shape, the protruding portions 515 may be positioned outside edges of a pair of sides facing each other, and the protruding portions 515 may not be formed outside edges of the other pair of sides facing each other. That is, the protruding portions 515 may be formed on the outer sides of the pair of intermediate portions 513a and 513c facing each other, and the protruding portions 515 may not be formed on the outer sides of the other pair of intermediate portions 513b and 513d facing each other.

The protruding portion 515 may have an arc shape. The protruding portion 515, having an arc shape, may overlap the lens barrel 100 in the optical axis direction. Because the protruding portion 515 overlaps the lens barrel 100 as described above, it is possible to improve the reliability of the portion of the lens barrel 100.

For example, the seating portion 511 may have a quadrangular frame shape with a pair of long sides and a pair of short sides. The protruding portions 515 may be formed on the outer sides of the intermediate portions 513a and 513c positioned outside the long sides, and the protruding portions 515 may not be formed on the outer sides of the intermediate portions 513b and 513d positioned outside the short sides. A maximum height of the protruding portion 515 may be larger than a height of a rim portion 530 positioned outside the edge of the short side.

The rim portion 530 may be positioned around the mounting region 510 and define an external periphery of the sub-housing 500. The rim portion 530 may be formed to be flat. The rim portion 530 may be higher in height than the seating portion 511 and lower in height than the protruding portion 515.

The rim portion 530 may include a convex portion 531 protruding outward. The convex portion 531 may protrude in a direction perpendicular to the optical axis. The convex portion 531 may be positioned only on the part of the rim portion 530. For example, the convex portion 531 may be formed outside the edges of the pair of sides facing each other among the four sides of the seating portion 511, which has a quadrangular frame shape. In this case, if the seating portion 511 has a quadrangular frame shape having a pair of long sides and a pair of short sides, the convex portion 531 may be positioned outside the edges of the long sides. The convex portion 531 may have an arc shape.

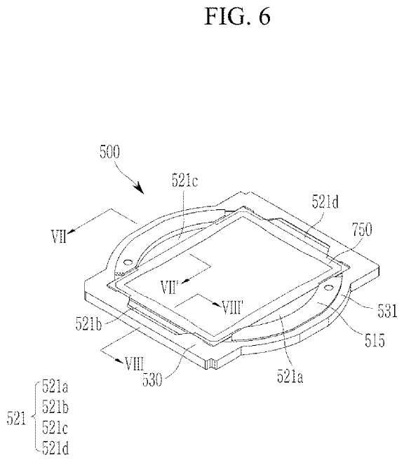

Hereinafter, sub-housings of camera modules according to other embodiments will be described with reference to FIGS. 6 to 11.

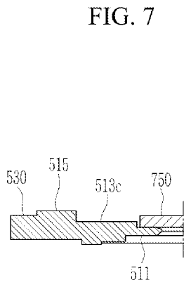

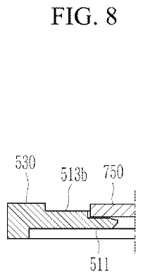

FIG. 6 is a perspective view illustrating a sub-housing of a camera module according to another embodiment, FIG. 7 is a cross-sectional view taken along line VII-VII′ in FIG. 6, and FIG. 8 is a cross-sectional view taken along line VIII-VIII′ in FIG. 6. The sub-housing of the camera module according to the present embodiment is similar to that according to the embodiment described with reference to FIGS. 1 to 5. A specific description of the identical constituent elements will be omitted.

With reference to FIG. 6, in the sub-housing 500 of the camera module, according to the present embodiment, intermediate portions 521a and 521c, which are positioned inside the protruding portions 515, may each have an arc shape. The seating portion 511 may have a quadrangular frame shape, and the protruding portions 515 may be positioned outside the pair of facing edges of the seating portion 511. In addition, if the seating portion 511 has long and short sides, the protruding portion 515 may be positioned outside the edge of the long side.

Intermediate portions 521b and 521d, which have the outer sides on which the protruding portions 515 are not positioned, may each have a quadrangular shape. FIG. 6 illustrates that the intermediate portions 521b and 521d, which have the outer sides on which the protruding portions 515 are not positioned, each have a trapezoidal shape. However, the present disclosure is not limited thereto.

With reference to FIGS. 7 and 8, the intermediate portions 521b and 521c (521) may be formed to be flat without being tapered.

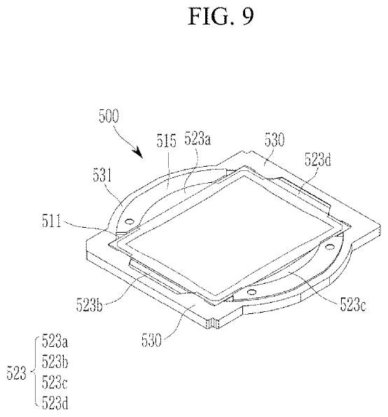

FIG. 9 is a perspective view illustrating a sub-housing of a camera module according to still another embodiment. The sub-housing of the camera module according to the present embodiment is similar to that according to the embodiment described with reference to FIGS. 1 to 8. A specific description of the identical constituent elements will be omitted.

With reference to FIG. 9, in the sub-housing 500 of the camera module according to the present embodiment, intermediate portions 523a and 523c, which are positioned inside the protruding portions 515, may each have an arc shape and have a tapered structure that becomes higher outward. The seating portion 511 may have a quadrangular frame shape having four sides, and the protruding portions 515 may be positioned outside the pair of facing edges of the seating portion 511. In addition, in case that the seating portion 511 has the long side and the short side, the protruding portion 515 may be positioned outside the edge of the long side.

The intermediate portion 523a and 523c, which are positioned inside the protruding portions 515, may each have a structure in which a level of a lowermost portion, among the portions having the tapered structures, increases toward the side on which the protruding portion 515 is not formed. In addition, if the seating portion 511 has the long side and the short side, the intermediate portions 523a and 523c may each have a structure in which a level of a lowermost portion, among the portions having the tapered structures, increases toward the short side direction.

Intermediate portions 523b and 523d, which have the outer sides on which the protruding portions 515 are not positioned, may each have a quadrangular shape and have a tapered structure that becomes higher outward.

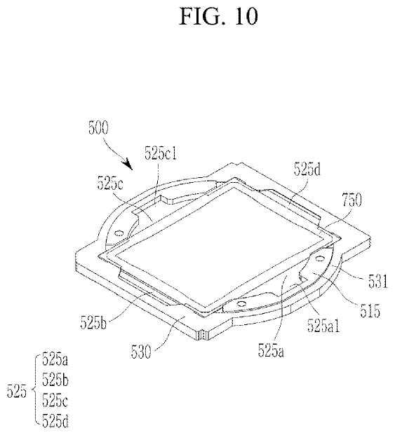

FIG. 10 is a perspective view illustrating a sub-housing of a camera module according to yet another embodiment. The sub-housing of the camera module according to the present embodiment is similar to that according to the embodiment described with reference to FIGS. 1 to 9. A specific description of the identical constituent elements will be omitted.

With reference to FIG. 10, in the sub-housing 500 of the camera module, according to the present embodiment, intermediate portions 525a and 525c, which are positioned inside the protruding portions 515, may each have an arc shape and have extension portions 525a1 and 525a2 protruding outward from the arc shape. The arc shape may protrude toward the protruding portion 515. Therefore, the protruding portion 515 may have a partially recessed portion. The seating portion 511 may have a quadrangular frame shape having four sides, and the protruding portions 515 may be positioned outside the pair of facing edges of the seating portion 511. In addition, in case that the seating portion 511 has the long side and the short side, the protruding portion 515 may be positioned outside the edge of the long side.

Intermediate portions 525b and 525d, which have the outer sides on which the protruding portions 515 are not positioned, may each have a quadrangular shape. FIG. 10 illustrates that the intermediate portions 525b and 525d, which have the outer sides on which the protruding portions 515 are not positioned, each have a trapezoidal shape. However, the present disclosure is not limited thereto.

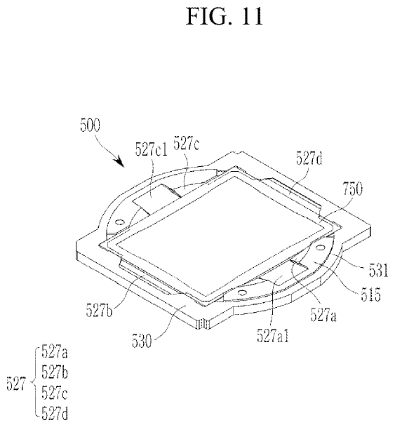

FIG. 11 is a perspective view illustrating a sub-housing of a camera module according to still yet another embodiment. The sub-housing of the camera module according to the present embodiment is similar to that according to the embodiment described with reference to FIGS. 1 to 10. A specific description of the identical constituent elements will be omitted.

With reference to FIG. 11, in the sub-housing 500 of the camera module, according to the present embodiment, intermediate portions 527a and 527c, positioned inside the protruding portions 515, may each have an arc shape with a tapered structure that becomes higher outward. The intermediate portions 527a and 527c positioned inside the protruding portions 515 may have stepped portions 527a1 and 527c1 provided on the middle portions thereof. The stepped portions 527a1 and 527c1 may further protrude outward than the arc shape. Therefore, the protruding portion 515 may have a partially recessed portion. The seating portion 511 may have a quadrangular frame shape having four sides, and the protruding portions 515 may be positioned outside the pair of facing edges of the seating portion 511. In addition, if the seating portion 511 has long and short sides, the protruding portion 515 may be positioned outside the edge of the long side.

Intermediate portions 525b and 525d, which have the outer sides on which the protruding portions 515 are not positioned, may each have a quadrangular shape. FIG. 11 illustrates that the intermediate portions 525b and 525d, which have the outer sides on which the protruding portions 515 are not positioned, each have a trapezoidal shape. However, the present disclosure is not limited thereto. Intermediate portions 527b and 527d, which have the outer sides on which the protruding portions 515 are not positioned, may each have a tapered structure that becomes higher outward.

Meanwhile, the image sensor module, according to another aspect, may include the image sensor 700, the main substrate 610 on which the image sensor 700 is mounted, the optical filter 750 positioned above the image sensor 700, and the sub-housing 500 in which the optical filter 750 is mounted.

The image sensor 700 may be mounted on the main substrate 610. The image sensor 700 may be electrically connected to the main substrate 610.

The main substrate 610 may be a PCB or an FPCB. The main substrate 610 may be electrically connected to the connector 650 and connected to an external device. The main substrate 610 may be connected to the connector 650 through the connection substrate 630.

The optical filter 750 may prevent light beams with a particular frequency band among the light beams passing through the lens from entering the image sensor 700. The optical filter 750 may include an infrared filter.

The sub-housing 500 may be positioned on the main substrate 610 and include the mounting region 510, in which the optical filter 750 is mounted, and the rim region 530 positioned around the mounting region 510.

The mounting region 510 may include the seating portion 511 on which at least a part of the lower surface of the optical filter 750 is seated, the intermediate portion 513 extending outward from the seating portion 511 and being higher in height than the seating portion 511 and lower in height than the optical filter 750, and the protruding portion 515 positioned on the outer side of at least a part of the intermediate portion 513 and being convex outward in a plan view.

The protruding portion 515 may protrude further than the rim region 530 in the direction opposite the main substrate 610. In addition, the protruding portion 515 may further protrude than the intermediate portion 513 in the direction opposite to the main substrate 610. The intermediate portion 513 positioned inside the protruding portion 515 may have an arc shape.

The opening portion OP may be positioned in the central portion of the sub-housing 500 and overlap the image sensor 700 in the optical axis direction. The seating portion 511 may have a quadrangular frame shape formed around the opening portion OP. The protruding portions 515 may be positioned outside the pair of facing edges of the seating portion 511 having a quadrangular frame shape.

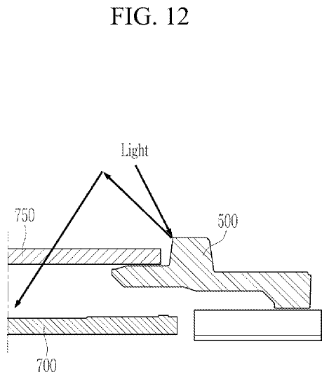

FIG. 12 is a cross-sectional view illustrating a state in which flare is caused by a sub-housing 500 according to a comparative example.

With reference to FIG. 12, when incident light is reflected by an edge of the mounting region 510 of the sub-housing 500 in which the optical filter 750 is mounted, the reflected light is reflected again by a lower surface of the lens, which causes flare.

With reference to FIGS. 7 and 8, the sub-housing 500 of the camera module and the image sensor module, according to the present disclosure, adopts the stepped design, such that the edge of the mounting region 510 in which the optical filter 750 is mounted is lower in height than the optical filter 750, which may prevent the light from reaching the edge of the sub-housing 500, thereby preventing flare from occurring through the above-mentioned route.

According to the camera module and the image sensor module according to the embodiment, it is possible to prevent the occurrence of flare by applying the stepped design to the sub-housing and preventing light from reaching the edge of the sub-housing.

The present disclosure has been made in an effort to provide a camera module and an image sensor module, which are capable of preventing the occurrence of flare by applying a stepped design to a sub-housing and preventing light from reaching an edge of the sub-housing.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a lens barrel;
a housing accommodating the lens barrel;
an image sensor, disposed below the lens barrel in an optical axis direction, mounted on a main substrate;
an optical filter disposed between the image sensor and the lens barrel; and
a sub-housing, disposed between the lens barrel and the main substrate, comprising a mounting region on which the optical filter is mounted, and a rim region disposed around the mounting region,
wherein the mounting region comprises a seating portion on which at least a part of a lower surface of the optical filter is seated, an intermediate portion extending outward and above from the seating portion and lower than an upper surface of the optical filter, and a protruding portion disposed on an outer side of at least a part of the intermediate portion and protruding upward.

2. The camera module of claim 1, wherein
in the optical axis direction, the protruding portion is disposed closer to the lens barrel than the rim region is to the lens barrel.

3. The camera module of claim 1, wherein
in the optical axis direction, the protruding portion is disposed closer to the lens barrel than the intermediate portion is to the lens barrel.

4. The camera module of claim 1, wherein
the intermediate portion disposed within the protruding portion has an arc shape.

5. The camera module of claim 1, wherein
the seating portion has a quadrangular shape, and
the protruding portion comprises a pair of protruding portions disposed outside a pair of facing edges of the seating portion, respectively.

6. The camera module of claim 5, wherein
the seating portion has a pair of long side surfaces and a pair of short side surfaces, and
the protruding portions are disposed on outside edges of the pair of long side surfaces.

7. The camera module of claim 6, wherein
a maximum height of the protruding portion is larger than a height of a rim portion disposed outside edges of the pair of short side surfaces of the seating portion.

8. The camera module of claim 5, wherein
the intermediate portion is disposed outside an edge of each of four sides of the seating portion, and the intermediate portion has a tapered profile.

9. The camera module of claim 8, wherein
the seating portion has a pair of long side surfaces and a pair of short side surfaces, and
a lowermost portion profile of the intermediate portion disposed outside edges of the long side surfaces increases toward the short side surfaces.

10. The camera module of claim 6, wherein
the intermediate portion disposed within the protruding portion has an arc shape.

11. The camera module of claim 6, wherein
the rim portion comprises a convex portion having an arc shape protruding outward from edges of the long side surfaces.

12. The camera module of claim 11, wherein
the protruding portion has an arc shape.

13. The camera module of claim 12, wherein
the protruding portion overlaps the lens barrel in the optical axis direction.

14. The camera module of claim 4, wherein
the intermediate portion having the arc shape has an extension portion protruding outward from the arc shape.

15. The camera module of claim 8, wherein
the intermediate portion comprises a stepped portion, and
the stepped portion has a portion protruding outward.

16. An image sensor module comprising:
a main substrate;
an image sensor disposed on the main substrate;
an optical filter disposed on the image sensor; and
a sub-housing, disposed on the main substrate, comprising a mounting region on which the optical filter is mounted, and a rim region disposed around the mounting region,
wherein the mounting region comprises a seating portion on which at least a part of a lower surface of the optical filter is seated, an intermediate portion extending outward from the seating portion and being higher than the seating portion and lower than the optical filter, and a protruding portion disposed outside at least a part of the intermediate portion and being convex outward in a plan view.

17. The image sensor module of claim 16, wherein
the protruding portion protrudes further than the rim region in a direction opposite to the main substrate.

18. The image sensor module of claim 16, wherein
the protruding portion protrudes further than the intermediate portion in a direction opposite to the main substrate.

19. The image sensor module of claim 16, wherein
the intermediate portion disposed inside the protruding portion has an arc shape.

20. The image sensor module of claim 16, wherein
the seating portion has a quadrangular shape, and
the protruding portion comprises a pair of protruding portions disposed outside a pair of facing edges of the seating portion, respectively.
